(19) United States
(12) Patent Application Publication
(10) Pub. No.: US 2015/0292101 A1
(43) Pub. Date: Oct. 15, 2015

(54) METHOD FOR COATING A SLIDING SURFACE OF A TROCHOID HOUSING IN A ROTARY ENGINE AND TROCHOID HOUSING COMPRISING A COATED SLIDING SURFACE

(71) Applicant: WANKEL SUPERTEC GMBH, Cottbus (DE)

(72) Inventors: Marko Gollasch, Vetschau (DE); Dankwart Eiermann, Weissensberg (DE)

(21) Appl. No.: 14/441,040

(22) PCT Filed: Oct. 11, 2013
(86) PCT No.: PCT/EP2013/071245

§ 371 Date: May 6, 2015

(30) Foreign Application Priority Data
Nov. 7, 2012 (DE) 10 2012 220 258.7

(51) Int. Cl. C25D 11/04; C25D 11/18; C25D 11/16; F01C 21/10

(52) U.S. Cl. CPC C25D 11/04; F01C 21/10; C25D 11/18; C25D 11/16; F05C 2251/10; F05C 2201/021

(57) ABSTRACT

The invention relates to a method for coating a running surface (2) of a trochoid housing (1) of a rotary engine, characterized in that a circumferential recess (5) is made in the running surface (2), which recess (5) is delimited by a land (6) at at least one transition region to a side face (3) of the trochoid housing (1). Furthermore, the invention relates to a trochoid housing (1) having a coated running surface (2).

The invention relates to a method for coating a running surface of a trochoid housing of a rotary engine and to a trochoid housing having a coated running surface.

Rotary piston internal combustion engines or rotary piston machines or rotary engines for short having a triangular piston rotor and a trochoid housing are also called rotary engines of the Wankel design in conjunction with the application. In addition to the piston rotor and the trochoid housing, rotary engines usually comprise two side parts and an eccentric shaft with an eccentric. Together with the trochoid housing, the piston rotor encloses three working chambers, in which a four-stroke process takes place during rotation of the piston rotor.

In rotary engines of the Wankel design, it is known for reasons of weight to use trochoid housings made from cast aluminum. In order to reduce wear of a running surface of the trochoid housing made from aluminum, it is known to provide the running surface with a wear-resistant surface coating. It is known, in particular, to apply a coating with ceramic particles. For coating, the material for the coating is applied with an extra allowance and the coated surface is subsequently finally machined by way of grinding disks. In a known method, a bevel is provided in the transition region from the running surface to a side face of the trochoid housing. The coating is applied and subsequently machined in such a way that the coated trochoid housing has a sharp edge in the transition region from the running surface to the side faces. However, there is the risk that the relatively brittle coating has spalling at the sharp edges after grinding. Trochoid housings of this type are reject parts that cannot be used.

It is therefore an object of the present invention to provide a method for coating a running surface of a rotary engine and to provide a rotary engine having a coated running surface, by way of which spalling at the edges is avoided.

This object is achieved by way of a method having the features of claim 1 and a rotary engine having the features of claim 10.

According to a first aspect of the application, a method for coating a running surface of a trochoid housing of a rotary engine is provided, in which method a circumferential recess is made in the running surface, which recess is delimited by a land at at least one transition region to a side face of the trochoid housing.

The coating is provided in the recess. The sensitive coating is protected laterally against damage by way of the at least one land.

In order to avoid leakage points between the trochoid housing and the side parts which are arranged on its side faces, sharp edges are to be provided in the transition region between the running surface and the side faces. Problems of an insufficient edge build-up of the coating at the transition region are avoided by way of the at least one land. The at least one land also prevents spalling of the edges during machining.

In one embodiment, the recess is made during casting. In advantageous embodiments, the recesses are made after casting, for example by means of CNC milling.

A recess is preferably made which is delimited in each case by a land at both transition regions to the two side faces.

In one embodiment, the recess is made with a depth which corresponds to a magnitude of a desired layer thickness plus a machining allowance. The coated surface is finally machined by way of grinding or the like, material being removed at the lands. A material thickness which is to be removed during machining is taken into consideration by the machining allowance. After machining, the coating therefore lies with a flush surface between the lands, the coating having the desired layer thickness.

In one embodiment, the recess is made in such a way that at least one narrow land, preferably two narrow lands remain. Here, “narrow lands” denote lands, the width of which at the free surface lies in the range of tenths of millimeters. It has been proven that narrow lands are sufficient to protect the coating laterally against damage. At the same time, a contact area of the lands with the piston rotor and therefore wear of the lands are kept low.

In a further embodiment, the recess is made in such a way that the recess ends at an angle with respect to the at least one land. In other words, the recess has a trapezoidal cross section. As a result, lands with a reinforced root region are produced, which lands have high strength with a low width at the free surfaces.

In a step which follows the shaping of the recess, a coating is applied into the recess and/or to the at least one land. The coating is applied with an additional allowance for final machining.

In one embodiment, a protective layer is produced, in particular by means of hard coating, on the recess and/or on the at least one land before the application of the coating. Hard coating, also known as hard anodizing, denotes an electrolytic oxidation of aluminum materials, in order to produce a protective layer. Anti-corrosion protection is achieved, in particular, by way of the protective layer. However, hard coating can have a negative effect on wear properties of the running surface. Anti-corrosion protection and anti-wear protection are achieved by way of the combination with a subsequent coating.

In a further embodiment, the side faces are machined before the application of the coating, the machining preferably taking place concentrically. In one embodiment, machining takes place by way of facing. The method makes it possible to already finally machine the side faces of the trochoid housing before the coating, it no longer being necessary for the side faces to be ground after the coating.

In order to prevent the coating getting onto the side faces, the machined side faces are masked before the application of the coating in advantageous embodiments. A masking of this type is possible in a simple way thanks to the lands.

According to a second aspect, a trochoid housing is provided for a rotary engine consisting of a housing material, preferably of aluminum and/or an aluminum alloy, with a coated running surface, a coating on the running surface being delimited by a land consisting of the housing material at at least one transition region to a side face of the trochoid housing, preferably at both transition regions to the side faces.

Further advantages of the invention result from the subclaims and from the following description of one exemplary embodiment of the invention which is shown diagrammatically in the drawings. Standardized designations are used in the drawings for identical or similar components. Features which are described or shown as part of one exemplary embodiment can likewise be used in another exemplary embodiment, in order to obtain a further embodiment of the invention.

In the drawings, diagrammatically:

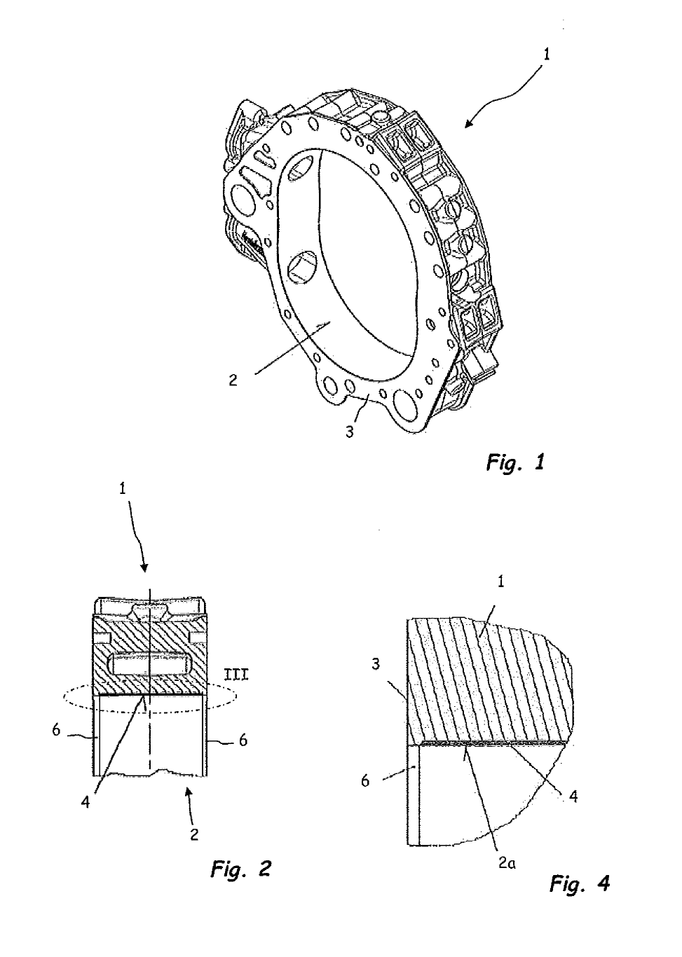

FIG. 1 shows a trochoid housing of a rotary engine having a running surface, in a perspective illustration,

FIG. 2 shows a cross section through the trochoid housing according to FIG. 1 having a running layer on the running surface,

FIG. 3a shows a detail III of the cross section according to FIG. 2 after preliminary machining for coating of the running surface,

FIG. 3b shows the detail III of the cross section according to FIG. 2 after the application of a coating to the running surface,

FIG. 3c shows the detail III of the cross section according to FIG. 2 after the method for coating the running surface is ended, and

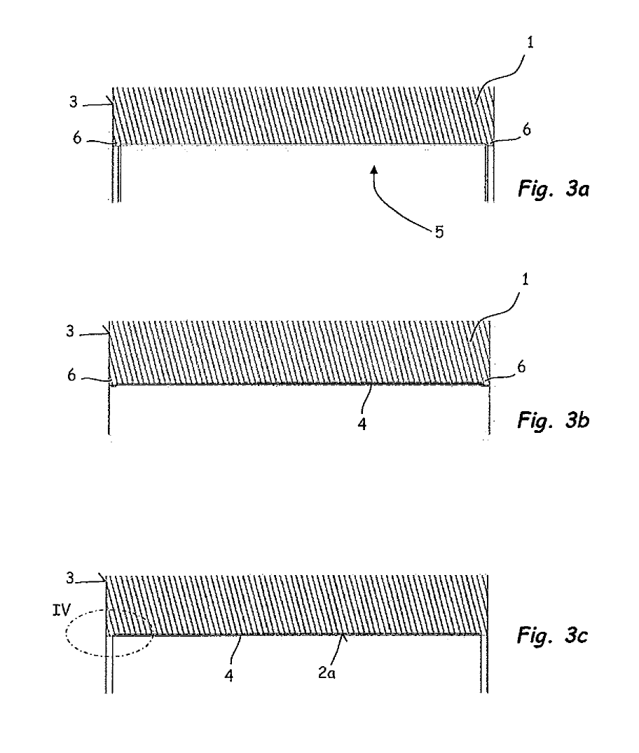

FIG. 4 shows a detail IV of the cross section according to FIG. 3 after the method for coating the running surface is ended, in an enlarged illustration.

FIG. 1 diagrammatically shows a perspective illustration of a trochoid housing 1 of a rotary engine having a running surface 2. During operation, a rotating, triangular piston rotor (not shown) is inserted into the trochoid housing 1. Side parts (not shown), also called side housings, are arranged on the side faces 3 of the trochoid housing 1. The piston rotor makes contact with the running surface 2 by way of its tips or piston corners and, together with the trochoid housing 1, encloses three working chambers, in which a 4-stroke process takes place during rotation of the piston rotor. Here, sealing strips which seal the working chambers with respect to one another during operation are usually provided on the piston corners of the piston rotor. The trochoid housing 1 is made from a housing material, for example from aluminum or from an aluminum alloy.

FIG. 2 diagrammatically shows a cross section through the trochoid housing 1 according to FIG. 1, a coating 4 which is called a running layer being applied to the running surface 2. The coating 4 is arranged between two lands 6 consisting of the housing material.

FIGS. 3a to 3c shows a detail III of the cross section according to FIG. 2 after various steps of a method for coating the running surface 2. FIG. 4 shows a detail IV of the cross section according to FIG. 3 after the method for coating the running surface 2 is ended, in an enlarged illustration.

As shown in FIG. 3a, first of all a recess 5 is made on an inner side of the trochoid housing 1 in the method for coating the running surface 2. In contrast to conventional coating processes, the running surface 2 is not pre-machined over the entire surface area. Rather, production of the recess 5 takes place in such a way that narrow lands 6 of the housing material remain at edges, that is to say in the transition region from the running surface 2 to the side faces 3.

In one embodiment, the recess 5 is made by means of CNC milling. A depth of the recess 5 is selected in such a way that the depth corresponds to the magnitude of the desired layer thickness plus a machining allowance.

As can be seen in FIG. 3a, the recess 5 ends at an angle with respect to the lands 6. A width of the lands 6 in the running surface is as small as possible and lies in the range of tenths of millimeters in one embodiment.

As shown in FIG. 3b, the coating 4 is applied in a following step of the method for coating the running surface 2. Here, the application of the coating 4 takes place with an additional allowance, a coating also being applied to the lands 6. The coating 4 is preferably applied in such a way that no material passes onto the side faces 3. As a result, it is possible to dispense with the grinding of the side faces 3 after coating and thus to simplify production. In order to avoid that a coating passes onto the side faces 3, the side faces 3 are masked in one embodiment.

As shown in FIG. 3c, machining of the coated surface, for example by means of grinding, takes place in a further step of the method for coating the running surface 2. As a result, a coated running surface 2a (see FIG. 4) is provided which is delimited laterally by the lands 6.

As mentioned above, a depth of the recess 5 is selected in such a way that the depth corresponds to the magnitude of the desired layer thickness plus a machining allowance. During the machining of the surface after the application of the coating, the machining allowance is removed at the lands 6 and the coating. After the machining, the coating 4 lies flush between the free surfaces of the lands 6, with the result that the coating 4 has the desired layer thickness.

As the detail IV according to FIG. 4 shows, in particular, a lateral land 6 consisting of the housing material remains in the critical edge regions of the trochoid housing 1. Here, a sharp edge is produced in the transition region between the running surface 2 and the side faces 3, which sharp edge ensures that no leakage points are produced during metallic contact with the side housings (not shown). Furthermore, the sensitive running layer is protected laterally against damage by way of the lands 6.

1. A method for coating a running surface (2) of a trochoid housing (1) of a rotary engine, characterized in that a circumferential recess (5) is made in the running surface (2), which recess (5) is delimited by a land (6) at at least one transition region to a side face (3) of the trochoid housing (1).

2. The method as claimed in claim 1, characterized in that the recess (5) is delimited in each case by a land (6) at both transition regions to the two side faces (3).

3. The method as claimed in claim 1 or 2, characterized in that the recess (5) is made with a depth which corresponds to a magnitude of a desired layer thickness plus a machining allowance.

4. Method according to claim 1, 2 or 3, characterized in that the recess is made in such a way that at least one narrow land (6), preferably two narrow lands (6) remain.

5. The method as claimed in one of claims 1 to 4, characterized in that the recess (5) is made in such a way that the recess (5) ends at an angle with respect to the at least one land (6).

6. The method as claimed in one of claims 1 to 5, characterized in that a coating (4) is applied into the recess (5) and/or to the at least one land (6).

7. The method as claimed in claim 6, characterized in that a protective layer is produced, in particular by means of hard coating, on the recess (5) and/or on the at least one land (6) before the application of the coating (4).

8. The method as claimed in claim 6 or 7, characterized in that the side faces (3) are machined before the application of the coating (4), the machining preferably taking place concentrically.

9. The method as claimed in claim 8, characterized in that the machined side faces are masked before the application of the coating (5).

10. A trochoid housing for a rotary engine consisting of a housing material with a coated running surface, characterized in that the coating on the running surface (2) is delimited by a land (6) consisting of the housing material at at least one transition region to a side face (3) of the trochoid housing (1), preferably at both transition regions to the side faces (3).
